(19) United States
(12) Patent Application Publication
(10) Pub. No.: US 2008/0101784 A1
(43) Pub. Date: May 1, 2008

(54) Method for calculating distance and actual size of shot object

(75) Inventor: Hsiu-O Hsu, Hsinchu City (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Altek Corporation, Hsinchu (TW)

(21) Appl. No.: 11/716,466

(22) Filed: Mar. 9, 2007

(30) Foreign Application Priority Data
Nov. 1, 2006 (TW) 095140450

(51) Int. Cl. G03B 13/18

(52) U.S. Cl. 396/89

(57) ABSTRACT

A method for calculating distance and actual size of a shot object is provided, which is applicable to an image capture device, and includes the following steps. First, a table of the corresponding relationship of the focus pulse and an object distance (distance between the image capture device and the shot object) is established. After being focused, the actual object distance is obtained by looking up the table. Under the circumstance of the known object distance and image distance, the image height of the shot object is obtained by calculating the corresponding pixel size of the image capture device, and thus the object height (actual size of the shot object) is easily calculated with the equation of “object distance/object height=image distance/image height”.

### CROSS-REFERENCE TO RELATED APPLICATIONS

This non-provisional application claims priority under 35 U.S.C. § 119(a) on Patent Application No(s). 095140450 filed in Taiwan, R.O.C. on Nov. 1, 2006, the entire contents of which are hereby incorporated by reference.

### BACKGROUND OF THE INVENTION

1. Field of Invention

The present invention relates to a method for calculating distance and actual size of a shot object, and more particularly to a method for calculating distance and actual size of a shot object by utilizing a relationship table between focus pulse and object distance and the pinhole imaging principle.

2. Related Art

When taking a picture, the pinhole imaging principle is utilized, and the photosensitive medium is used to store the image. According to the pinhole imaging principle, the actual scene is projected on the photosensitive medium through the lens set of the camera, and the photosensitive medium, such as negative film, Charge Coupled Device (CCD), or Complementary Metal-Oxide Semiconductor (CMOS), is capable of recording the light beams of the actual scene after being shot, and converting the light beams to an image that can be recognized as the actual scene through chemical or digital process.

However, the actual size of the actual scene cannot be obtained from the image generated after the actual scene was shot by a camera. Therefore, as for the scene that requires marking the size as a reference, an object is usually added in the image for being shot as a length reference during the shooting process, for example, ruler or the commonly used coin. However, if merely the size of the scene needs to be simply marked, the above object used as the reference can be used to solve the problem. But, if the detailed dimension of the shot scene needs to be indicated, the above method gets some trouble. For example, when shooting a coat, if only a ruler or a coin is placed beside the coat, the person cannot correctly know the size of the coat upon looking at the picture. Therefore, in order to mark the size of the coat, the most direct method is measuring the length of the coat and marking the measured length. However, since the coat has a plurality of parts, the sizes of the parts desired by individual viewers are usually different from each other, if the size of the part desired by the viewer is not marked, the viewer still has to ask the photographer about the size of the part that he/she wants to know. The photographer has to again find out the shot coat, measure the size of the part desired by the viewer and then tell him/her. Such situation is a trouble for both the photographer and the viewer. Therefore, how to provide a function of directly knowing the actual size of the shot scene from the picture has become a problem to be solved.

### SUMMARY OF THE INVENTION

In view of the above problems, the present invention is mainly directed to providing a method for calculating distance and actual size of a shot object, wherein a table of focus pulse and corresponding object distance is established in an image capture device; the image capture device utilizes the table to calculate the object distance; since the image distance and the pixel size are built-in parameter values of the image capture device, after the object distance has been calculated, the object height is calculated with the equation of “object distance/object height=image distance/image height”, thereby achieving the effect of obtaining the actual size of the shot object. Therefore, the problem in the prior art that the actual size of the shot scene cannot be obtained directly from the picture is solved.

In order to achieve the above object, the present invention discloses a method for calculating distance of a shot object, which comprises: establishing a table containing each focus pulse and the corresponding object distance; focusing the object to output a focus pulse; when the output focus pulse exists in the table, reading the corresponding object distance; and when the output focus pulse does not exist in the table, reading two focus pulses adjacent to the output focus pulse and the corresponding two object distances from the table to calculate the object distance between the object and the image capture device.

The method for calculating actual size of the shot object disclosed in the present invention comprises: reading a stored image file of the object shot by the image capture device; reading an object distance, an image distance, and a pixel size when shooting the object; selecting a measurement target from the image file; calculating a number of the pixels of the measurement target, multiplying the number of pixels with the pixel size to obtain the image height; and calculating the object height, i.e., actual size of the measurement target, according to the equation of “object distance/object height=image distance/image height”.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus is not limitative of the present invention, and wherein:

FIG. 1 is a schematic view of a conventional pinhole imaging principle;

FIG. 2 is a flow chart of a method for calculating the distance of the shot object according to the present invention;

FIG. 3A is a table of the corresponding relationship between focus pulse and object distance according to an embodiment of the present invention;

FIG. 3B is a table of the corresponding relationship between focus pulse, zooming segment, and object distance according to an embodiment of the present invention;

FIG. 4 is a flow chart of a method according to the present invention;

FIG. 5A is a schematic view of a conventional EXIF data field;

FIG. 5B is a schematic view of the stored pixel size and the EXIF data field according to an embodiment of the present invention;

FIG. 6A is a schematic view of selecting the upper edge of the coat according to an embodiment of the present invention; and

FIG. 6B is a schematic view of selecting the lower edge of the coat according to an embodiment of the present invention.

### DETAILED DESCRIPTION OF THE INVENTION

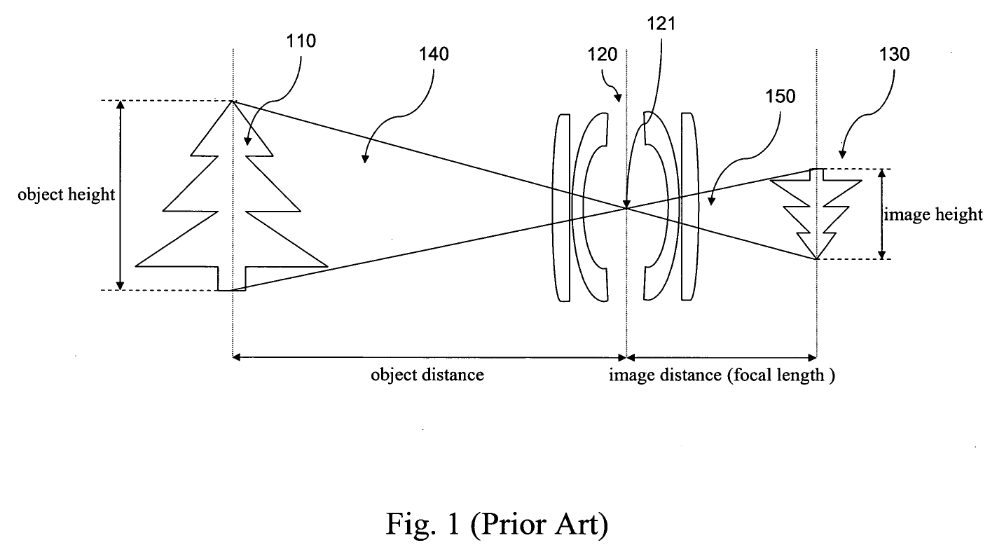

FIG. 1 is a schematic view of a pinhole imaging principle. As shown in the figure, a first triangle 140 formed by an object 110 being shot and the optical center 121 of the lens set 120 of the image capture device and a second triangle 150 from by the image of the object 110 on the photosensitive medium 130 and the optical center 121 of the lens set 120 are similar triangles. Thus, the ratio of the base to the height of the first triangle 140 equals to the ratio of the base to the height of the second triangle 150, wherein the base and the height of the first triangle 140 are respectively the object height and the object distance, and the base and the height of the second triangle 150 are respectively the image height and the image distance, therefore, “object height/object distance=image height/image distance”.

In order to recognize the image on the photosensitive medium 130 as the object 110, the distance between the lens set 120 of the image capture device and the photosensitive medium 130, i.e., the focal length, must be adjusted, so as to make the image on the photosensitive medium 130 clear, which is called focusing. As the progress of the science and technology, the existing image capture device already has the automatic focusing function.

When the image capture device automatically focuses, the detector on the photosensitive medium (e.g., CCD or CMOS) in the image capture device continuously receives light beams, and then converts the brightness information of the light beams into amplitudes. Since the image generated by the correct focal length is sharp (clear), the difference between the maximum amplitude and the minimum amplitude is the largest. If the focal length is incorrect, the image is correspondingly vague, and the amplitude is not significant. Therefore, the image capture device adjusts the position of the lens in the lens set until the amplitude reaches the maximum level, and at this time, the focal length is the most appropriate one.

During the automatically focusing, the image capture device moves the automatic-focusing lens back and forth within the lens set, therefore, the automatic-focusing pulse refers to the distance for which the automatic-focusing lens moves, wherein 1 pulse equals to 0.0125 mm.

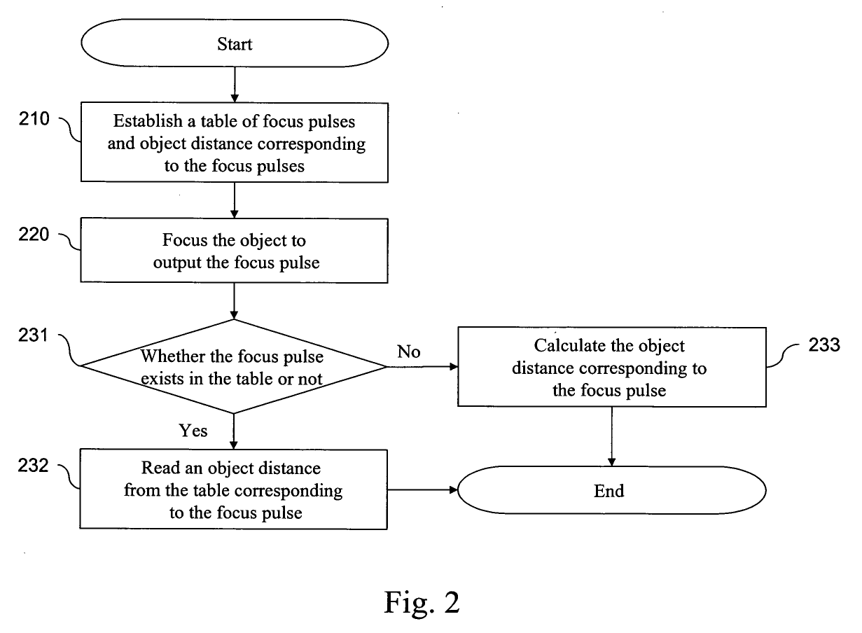

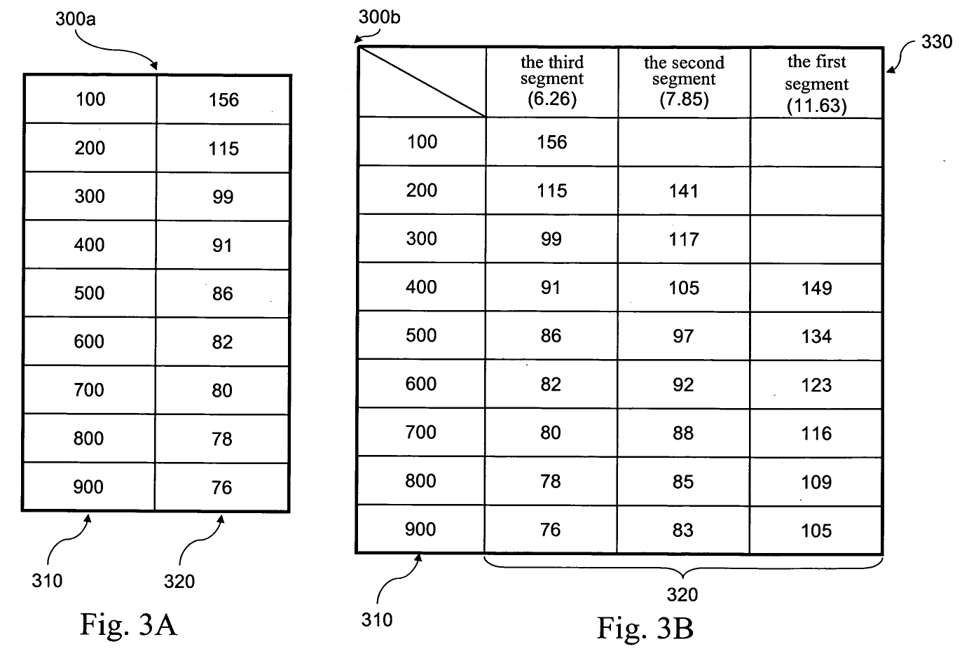

The operation system and method of the present invention are illustrated below through an embodiment, and a digital camera is taken as an example for the image capture device in this embodiment, but not limited to this, and a coat is taken as an example for the object for being shot in this embodiment, but not limited to this. Referring to FIG. 2, a flow chart of the method for calculating the distance of the shot target according to the present invention is shown. When a first user uses the method of the present invention to enable others to obtain the actual size of the shot coat directly from the image obtained after the shooting process, first, a digital camera containing a table 300a as shown in FIG. 3A must be used (Step 210), wherein the table 300a contains a focus pulse field 320 of various focus pulses and an object distance field 310 of the corresponding object distances.

Then, the first user uses the digital camera to take a picture of the coat, when the first user half presses the shutter button, the digital camera automatically focuses the target for being shot (i.e., the coat), and when the digital camera moves the automatic-focusing lens to the position of 80 pulse, the automatically focusing process is completed, so 80 is the focus pulse (Step 220). After the automatically focusing step, the digital camera reads the focus pulse before and after the automatic-focusing lens moves, and the object distance corresponding to the focus pulse is found out from the table 300a (Step 231). As known from FIG. 3A that, the object distance corresponding to the focus pulse of 80 is 700 (mm) (Step 232), thereby obtaining the distance between the shot coat and the digital camera. If the digital camera moves the automatic-focusing lens to a position of 87 pulse, the digital camera determines that the object distance corresponding to the focus pulse of 87 is not recorded in the table 300a (Step 231), so the digital camera reads two sets of data, i.e., the adjacent focus pulse 91 and the object distance 400 (mm), the focus pulse 86 and the object distance 500 (mm), and the actual object distance is obtained to be 480 (mm) by way of interpolation through 91−87/91−86=400−actual object distance/400−500 (Step 233).

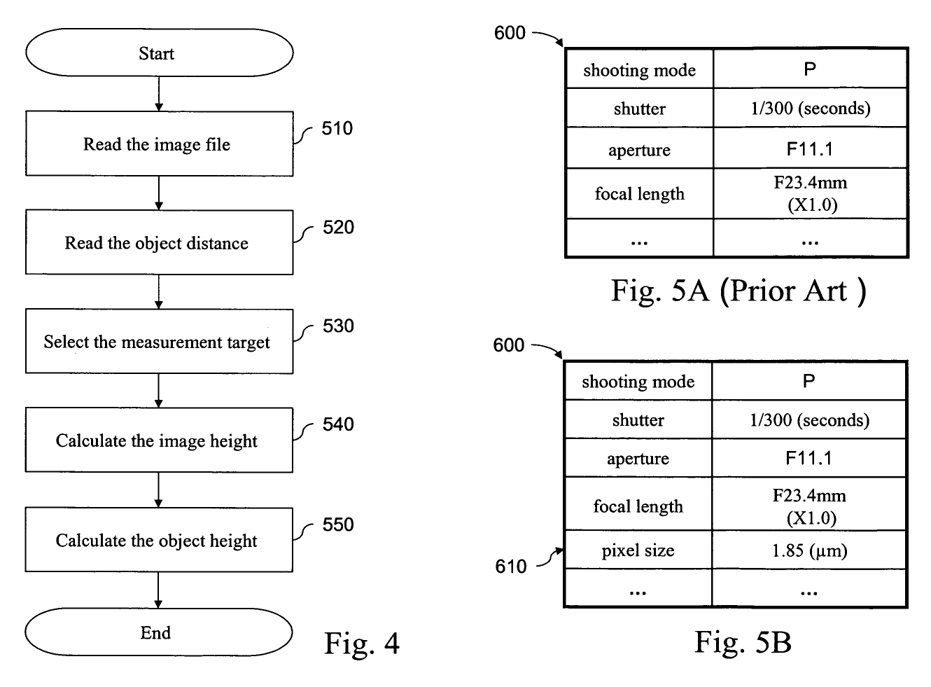

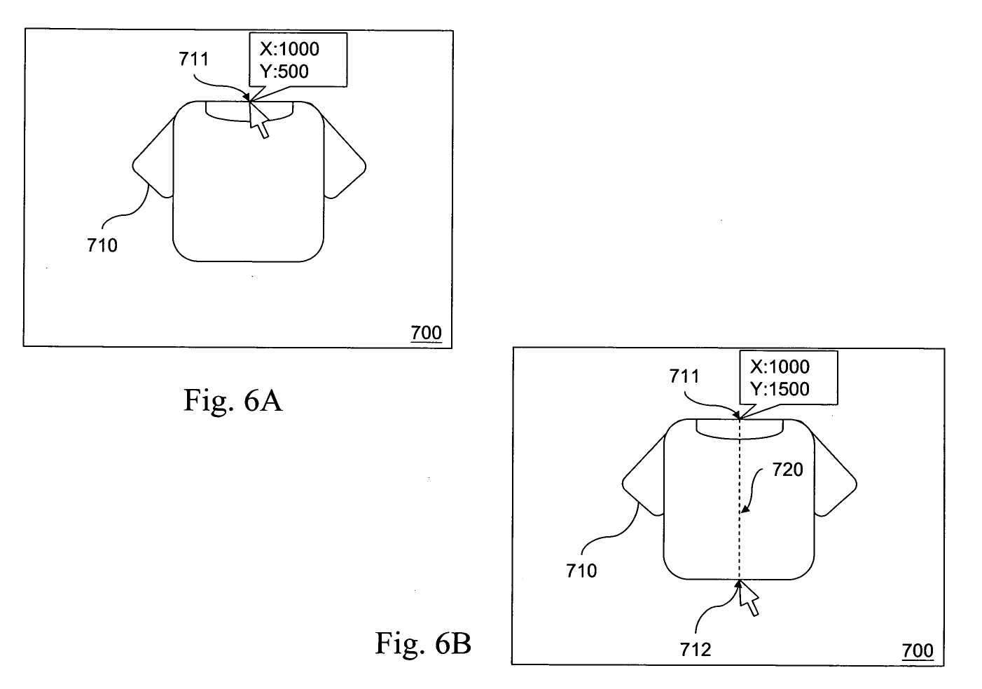

Through the above process, the distance between the shot object, i.e., the coat, and the digital camera is obtained. Then, the method for calculating actual size of the object in the picture is illustrated below with reference to FIG. 4. When the digital camera is used to shoot the coat, the calculated distance, the image distance, and the pixel size of the image file are together stored in the image file generated during the shooting process, for example, in the EXIF information field of the JPEG file. FIG. 5A is a schematic view of a part of the information of the EXIF. The EXIF information field exists in the file header of the JPEG file in the form of 0xFF (1 byte)+Marker Number (1 byte)+Data size (2 bytes)+Data (n bytes), such that the pixel size field 610 that does not exist in the EXIF can be easily added in the EXIF information field, so as to record the pixel size, as shown in FIG. 5B. Therefore, after a second user has obtained the image file, the image viewing program for executing the method of the present invention is used to read the image file (Step 510), the image viewing program displays the image file in the frame 700 for being shown to the second user, as shown in FIG. 6A. If the second user wants to known the actual size of the coat 710 in the image file, a target for being measured is selected in the image file (Step 530), for example, the user first clicks and selects the upper edge 711 of the coat, and then clicks and selects the lower edge 712 of the coat, and the dashed line 720 in FIG. 6B shows the length of the target for being measured (from the upper edge of the coat to the lower edge of the coat). While the user selects the target, the image viewing program reads the object distance, the image distance, and the pixel size from the image file (Step 520), and the distance is calculated to be 1500−500=1000 (pixel) by using the coordinate (1000, 500) corresponding to the image file when the second user clicks to select the upper edge 711 of the coat and the coordinate (1000, 1500) corresponding to the image file when the user clicks to select the lower edge 712 of the coat. The distance is multiplied by the pixel size to obtain the image height (Step 540), that is, in this embodiment, the image distance is 6.26 (mm), the image height is 1000*1.85 (μm)=1.85 (mm), and the object distance is 480 (mm). The object height is calculated to be 141.853(mm) by using the equation of “object distance/object height=image distance/image height” (Step 550), and the calculated object height is the length of the measured target, i.e., the length from the upper edge 711 to the lower edge 712 of the coat.

Besides the above calculation method, since not all the image files are used to store the additional information such as the object distance, the image distance and the pixel size, the second user may input the object distance, the image distance of the image file during the shooting process, and the pixel size of the digital camera into the image viewing program, such that the image viewing program reads the object distance, the image distance, and the pixel size (Step 520). Therefore, after the second user selects the target (Step 530), the object height can be calculated by the equation of “object distance/image distance=object height/image height” (Step 540, Step 550) for being provided to the user as a reference. Thus, the present invention solves the problem in the prior art, and obtains the actual size of the shot object directly from the image file.

In addition, the image viewing program for executing the method of the present invention is further capable of automatically detecting the edge. After the image viewing program reads the image file, each edge of the object in the image file can be automatically detected. Since when shooting the coat, there is surely a color difference between the coat and the background, the image viewing program finds out the edge of the coat by utilizing the color difference, and the actual size between the edges is calculated first, and once the second user selects the target, the actual size can be displayed.

Furthermore, since the existing digital cameras have been converted from the fixed focal lens set to the varifocal lens set, the table 300b stored in the digital camera actually further contains a zooming segment 330. As shown in FIG. 3B, the digital camera has three zooming segments: the first segment Z1, the second segment Z2, and the third segment Z3, and the focal lengths are 6.26, 7.85, and 11.63 (mm) respectively, wherein the blank parts indicate that the object for being shot cannot be focused at the corresponding object distances, that is, an clear image cannot be obtained. Therefore, when using the second zooming segment, the digital camera moves to the position of the 105^{th} pulse thereby achieving the automatically focusing process, which indicates that the object distance is 400 (mm).

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for calculating distance of a shot object, applicable to an image capture device, comprising:
establishing a table containing at least one focus pulse and an object distance corresponding to each focus pulse;
focusing the object to output the focus pulse;
when the focus pulse exists in the table, reading an object distance corresponding to the focus pulse; and
when the focus pulse does not exist in the table, reading two focus pulses adjacent to the output focus pulse and two object distances corresponding to the two adjacent focus pulse from the table to calculate the object distance accordingly.

2. The method for calculating distance of a shot object as claimed in claim 1, wherein the step of calculating the object distance is achieved by way of interpolation.

3. A method for calculating actual size of a shot object, comprising:
reading a stored image file of the object shot by an image capture device;
reading an object distance, an image distance, and a pixel size when the object is shot;
selecting a measurement target from the image file;
calculating a number of pixels of the measurement target, and multiplying the number of pixels with the pixel size to obtain an image height; and
calculating an object height, i.e., the actual size of the measurement target, according to an equation of “object distance/object height=image distance/image height”.

4. The method for calculating actual size of a shot object as claimed in claim 3, wherein the step of reading the object distance comprises reading the object distance from the image file.

5. The method for calculating actual size of a shot object as claimed in claim 3, wherein the step of reading the object distance comprises reading an input value as the object distance.

6. The method for calculating actual size of a shot object as claimed in claim 3, wherein the step of reading the image distance comprises reading the image distance from the image file.

7. The method for calculating actual size of a shot object as claimed in claim 3, wherein the step of reading the image distance comprises reading an input value as the image distance.

8. The method for calculating actual size of a shot object as claimed in claim 3, wherein the step of reading the pixel size comprises reading the pixel size from the image file.

9. The method for calculating actual size of a shot object as claimed in claim 3, wherein the step of reading the pixel size comprises reading an input value as the pixel size.

10. The method for calculating actual size of a shot object as claimed in claim 3, wherein the step of selecting the measurement target comprises selecting a first measuring position and a second measuring position from the image file.

11. The method for calculating actual size of a shot object as claimed in claim 3, wherein the step of selecting the measurement target comprises automatically detecting edge positions of the measurement target.
